(19) United States
(12) Patent Application Publication
(10) Pub. No.: US 2009/0036162 A1
(43) Pub. Date: Feb. 5, 2009

(54) COMBINATIONAL MOBILE COMMUNICATION DEVICE HAVING SWAPPABLE FUNCTION EXPANSION COMPONENTS

(75) Inventor: Kuo-Tai HSU, Hsin-Tien (TW)

Correspondence Address: Workman Nydegger;1000 Eagle Gate Tower, 60 East South Temple, Salt Lake City, UT, 84111, US

(73) Assignees: GIGA-BYTE COMMUNICATIONS, INC., Hsin-Tien (TW); GIGA-BYTE TECHNOLOGY CO., LTD., Hsin-Tien (TW)

(21) Appl. No.: 11/833,842

(22) Filed: Aug. 3, 2007

(51) Int. Cl. H04M 1/00

(52) U.S. Cl. 455/557

(57) ABSTRACT

A combinational mobile communication device includes a communication device main-body and at least a swappable function expansion component. The design and structure of the swappable function expansion component is modularized, thus making it suitable to combine with a communication device main-body into an integral mobile communication device. The swappable function expansion component includes a function expansion module, and a shell. This shell can be combined with a communication device main-body to form a part of the outer shell of a mobile communication device, such as a front outer shell, a back outer shell, or a side outer shell. The communication device main-body may be combined with a plurality of swappable function expansion components as required through the respective connection interfaces, hereby achieving the objective of providing increased/decreased functions depending on the requirements of a user, without increasing the overall volume of a combinational mobile communication device significantly.

### BACKGROUND

1. Field of Invention

The invention relates to a mobile communication device, and in particular to a combinational mobile communication device realized through combining swappable function expansion components with a communication device main-body.

2. Related Art

In the early stage of the development and application of mobile phone technology, the mobile phone is only designed for dialing/receiving telephone calls, as such, the design of handset is very much primitive and simplified. Usually, a mobile phone handset merely includes the necessary communication elements, circuitry, telephone press keys, earphone, speaker phone, and display screen as required, and the frequency of clock pulses carried by a microprocessor internal of the mobile phone handset is relatively low. However, with the progress and development of mobile calculation and manipulation capabilities, the functions of mobile phone handset are not limited to dialing/receiving phone calls, upon incorporating the microprocessor capable of carrying higher frequency clock pulses and a plurality of specific function expansion modules. By way of example, the embedded camera/video module is incorporated for taking pictures, the embedded satellite navigation module is incorporated for transportation navigation, and the imbedded Blue Tooth wireless communication module is incorporated for transmitting electronic files. As such, increasing numbers of practical and convenient functions are incorporated into mobile phone handset.

However, as the functions of mobile phone become more and more diversified and complete, the number of embedded functional components is increasing, so that the volume of mobile phone handset is getting increasingly large, thus it becomes not suitable for the user to carry. Usually, not all the functions provided in a mobile phone handset are required by a particular user. For example, for the occasions and locations where electronic devices having picture-taking functions are not allowed, then the mobile phone handset having built-in digital camera capability could constitute a limit and inconvenience. In addition, some of the users are required to replace the old and purchase the new mobile phone handset just for one or two newly added functions, thus the phenomenon that the whole handset has to be replaced just for such a small scale functional expansion or upgrade is not economic at all. Presently, the solution to the above-mentioned problem that some of the built-in functions are not required by the user or not suitable for some occasions, and that the whole handset has to be replaced just for small scale expansion or upgrade, is to realize the functional expansion or upgrade through the outside-attached modules. Therefore, when these functions are required by a user, then the outside attachable modules (such as the camera module or satellite navigation module) are attached to the mobile phone handset. However, this kind of outside attachable module has its shortcomings and limitations. The reason for this is that, the volume of a mobile phone handset is getting larger, and its overall outer appearance lacks consistency; moreover, the number of outer connection ports of a handset tends to limit the number of modules that can be outside-attached to a handset at the same time.

### SUMMARY OF THE INVENTION

In view of the above-mentioned drawbacks and shortcomings of the conventional mobile phone handset that the outside-attached function expansion module occupies too much space, inconvenient to carry, and that a small scale expansion or upgrade would require to replace the entire handset, the objective of the invention is to provide a combinational mobile communication device, such that the number of functional accessories of such a mobile communication device can be increased or decreased depending on the actual requirements, yet the volume of the mobile communication device will not increase significantly.

To achieve the above-mentioned objectives, the combinational mobile communication device of the invention is composed of at least a swappable function expansion component and a communication device main-body. According to a preferred embodiment of the invention, such a swappable function expansion component includes a function expansion module and a shell. Wherein, the function expansion module is used to provide at least an added or expanded function for the selection and utilization of the combinational mobile communication device; while the shell is used to carry such a function expansion module to form the afore-mentioned swappable function expansion component. It is worth mentioning that, this shell is a part of a larger shell that forms as a part of this combinational mobile communication device. For example, in a preferred embodiment of the invention, the shell of the combinational mobile communication device is realized through combining at least one (or more) shell(s) of the swappable function expansion component with a communication device main-body.

As mentioned above, the multiple additional functions of the invention are realized through a plurality of swappable function expansion components, and these swappable function expansion components are interconnected through a plurality of connection interfaces, thus realizing a mobile communication device. In expanding or replacing the functions of a mobile communication device, the swappable function expansion components to be replaced are plugged off, and the swappable function expansion components to be required are plugged on, thus achieving the expansion or upgrade of the mobile communication device.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow for illustration only, and thus are not limitative of the present invention, and wherein:

FIG. 1 is a schematic diagram of a swappable function expansion component according to an embodiment of the invention;

FIG. 2 is a schematic diagram of a communication device main-body according to an embodiment of the invention;

FIG. 3 is a schematic diagram of a combinational mobile communication device according an embodiment of the invention; and

FIG. 4 is a schematic diagram of another combinational mobile communication device according another embodiment of the invention.

### DETAILED DESCRIPTION OF THE INVENTION

The purpose, construction, features, and functions of the invention can be appreciated and understood more thoroughly through the following detailed description with reference to the attached drawings.

The combinational mobile communication device of the invention is composed of two parts: a swappable function expansion component and a communication device main-body. The communication device main-body may select at least a specific swappable function expansion component, and combine with it to form a mobile communication device. Thus, through assembling a swappable function expansion component with a communication device main-body, the number of swappable function expansion components attached can be increased or decreased depending actual requirements. As such, the attached swappable function expansion component (s) is actually an integral part of a mobile communication device, thus the attaching and detaching of various swappable function expansion components will not affect or increase the overall volume of a mobile communication device significantly.

In the following, the combinational mobile communication device and swappable function expansion component of the invention will be described in detail.

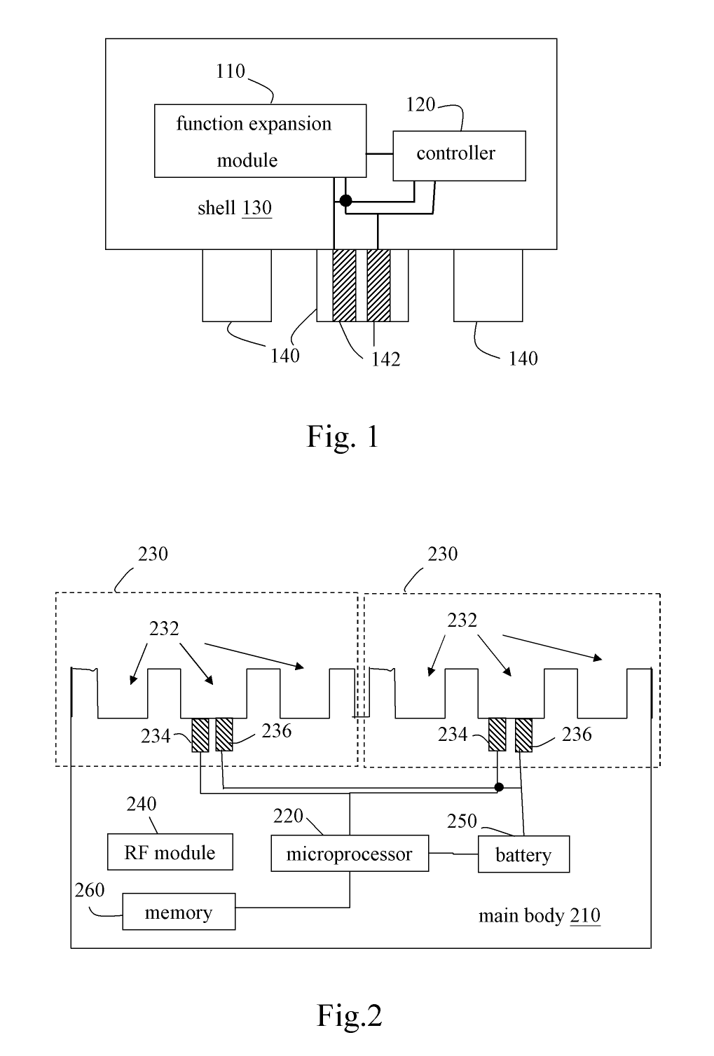

Firstly, the swappable function expansion component of the invention is described. Refer to FIG. 1 for a schematic diagram of a swappable function expansion component according to an embodiment of the invention. In the present embodiment, each of the respective swappable function expansion components includes a function expansion module 110, as controller 120, and a shell 130. The function expansion module 110 provides at least an additional function for selection and utilization of the communication device main-body, such as a keyboard input function expansion module, a handwriting input function expansion module, and a photographing and picture—taking function expansion module. When the controller 120 receives a control signal generated by a communication device main-body, the controller 120 will activate the function expansion module 110 to execute the corresponding functions according to the control signal. For example, in case that the function of an attached function expansion module 110 is for satellite navigation, thus when the controller 120 receives from the communication device main-body a satellite navigation related control signal, it will activate function expansion module 110 to execute the satellite navigation function. Similarly, when the communication device main-body transmits a control signal indicating terminating the satellite navigation function, the controller 120 receiving the control signal will terminate the satellite navigation function of function expansion module 110. In addition, the function of shell 130 is to carry the above-mentioned function expansion module 110 and controller 120. In the present embodiment, the shell 130 is used to package function expansion module 110 and controller 120 integrally into a swappable function expansion component. The bottom of shell 130 is provided with at least an insertion pin 140 for being inserted into at least an insertion hole on the communication device main-body, hereby securing shell 130 to the communication device main-body. The communication device main-body is provided with at least a portion (namely, a connection interface) for receiving a swappable function expansion component. The bottom of each of the respective connection interfaces is provided with at least an insertion hole for receiving the above-mentioned insertion pin 140. In the later paragraphs, the functions and constructions of the various portions of communication device main-body will be described in detail.

As mentioned above, some of the insertion pins of the swappable function expansion component are each provided with at least a metal plate. One end of the metal plate is connected electrically to a function expansion module 110 and a controller 120, while the other end of the metal plate is exposed to air at the bottom of an insertion pin, and is used to connect electrically a swappable function expansion component to a communication device main-body, when the swappable function expansion component is inserted into the communication device main-body, hereby obtaining the power required for the operation of the swappable function expansion component, and also receiving a control signal transmitted from communication device main-body. In the present invention, the swappable function expansion component is provided with three insertion pins 140, the center insertion pin is provided with two metal plates 142, thus power and control signals are transmitted through metal wires connected to a function expansion module 110 and a controller 120 respectively.

In some of the embodiments, shell 130 may include a connection port, such as a USB port or a 1394 connection port, that is connected to a communication device main-body for transmitting data. Depending on the function characteristics, the swappable function expansion component may be classified as: telephone keyboard module, pressure sensor control key module, touch screen module, fingerprint identification module, music broadcaster module, camera back cover module, clock module, and memory expansion back cover module. In some of the embodiments, the swappable function expansion component may be provided with a plurality of function expansion modules inside. For example, the camera, video device, wireless Blue Tooth and WiFi function expansion modules can be integrated into a single swappable function expansion component, and that can be used to take pictures or films, and then transmit the pictures or films taken to a computer through Blue Tooth or WiFi function expansion modules.

Incidentally, the above-mentioned shell is merely an integral part of a mobile communication device, it can be a frontal outer shell/shell cover, a back outer shell/shell cover or a side outer shell/shell cover. Through the utilization of connection interfaces, these shells are combined and integrated with communication device main-body, hereby realizing the objective of providing user with rapid increase/decrease of expanded functions depending on the actual requirements, and in attaching the swappable function expansion components for increasing the functions of a mobile communication device, its overall volume will not increase significantly.

Subsequently, the communication device main-body of a mobile communication device of the invention is described. Refer to FIG. 2 for a schematic diagram of a communication device main-body according to an embodiment of the invention. As shown in FIG. 2, the communication device main-body includes a main-body 210, a microprocessor 220, and other required elements (such as, a RF module 240, a battery 250, a memory 260, and other communication elements required by the mobile communication device). The main-body 210 contains at least a connection interface 230 for receiving and accommodating the above-mentioned swappable function expansion components. Each of the respective connection interfaces 230 is provided with at least an insertion hole 232 (or insertion slot), used for the insertion of at least an insertion pin of the swappable function expansion components. Some of the insertion holes are each embedded with at least a metal plate 234, and that is used to electrically connect an insertion pin to a swappable function expansion component upon insertion of an insertion pin, supply power to the swappable function expansion component, and also transmit control signals to this swappable function expansion component. In the present embodiment, one end of a left side metal plate 234 (shown as a block having reverse slant lines) in an insertion hole 232 is connected to a microprocessor 220 for transmitting control signals or data; while one end of a right side metal plate 236 (shown as a block having reverse slant lines) is connected to a battery 250, thus providing power to the swappable function expansion component required for it normal operation through the inserted insertion pin. A microprocessor 220 is disposed inside the main-body, and upon insertion of the swappable function expansion component into a connection interface, the electrical signals therein are changed due to the conducting state of metal plate 234 in an insertion hole 232, hereby triggering the microprocessor 220 to detect the electrical signals. When the microprocessor 220 detects the variations of electrical signals on the embedded metal plates in some of the insertion holes of connection interfaces, it may determine the type of the inserted swappable function expansion component based on the characteristics of the electrical signals, such as the magnitude of the voltage (current), or the data carried on the signals. Upon determining the type of the swappable function expansion component, the microprocessor 220 will generate control signals in controlling the activation and operation of the swappable function expansion component.

In the present embodiment, the main-body 210 further includes a RF module 240, a battery 250, and a memory 260. Upon receiving incoming call signals utilizing RF module 240, microprocessor 220 will send out control signals, hereby controlling swappable function expansion component in temporarily to stop executing a particular attached function. By way of example, in case that the swappable function expansion component concerned is a music broadcast module, then on receiving incoming call signals, the microprocessor will send out control signals to terminate the broadcast of music until the completion and termination of the incoming call. Then, the microprocessor will issue another control signal to resume the broadcast of music. In addition, the memory 260 in main-body 210 may be used to store the data received by the swappable function expansion component, and when a particular swappable function expansion component is removed, the memory may selectively remove the data received previously. For example, in case that the swappable function expansion component attached is for setting the subject scene of a mobile phone handset, then the attached swappable function expansion component is used to input a subject scene, for example, a scene of a movie as a table cloth for the screen of the handset, or set the accompanying music of a movie as the ring and sound effect for the incoming calls of the handset. When this particular swappable function expansion component is detached, a user may choose to keep the input data (namely, storing the subject scene in a memory), or remove that subject scene and resume the original settings of the mobile communication device.

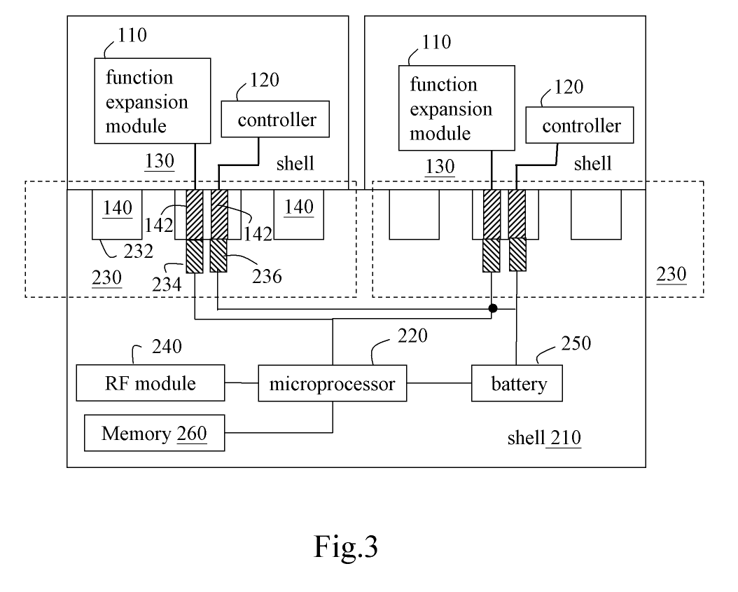

Moreover, refer to FIG. 3 for a schematic diagram of a combinational mobile communication device according to an embodiment of the invention. As shown in FIG. 3, a mobile communication device is provided with at least a swappable function expansion component and a communication device main-body. The functions and constructions of the various elements of the swappable function expansion component and the communication device main-body are described as above, and it will not be repeated here for brevity. In the following descriptions, the present embodiment is taken as an example. The communication device main-body is provided with two connection interfaces 230, with each of the two connection interfaces 230 having three insertion holes 232 (insertion slots) respectively. The bottom of the swappable function expansion component is also provided with three insertion pins 140, and those insertion pins 140 are used to be inserted respectively into the three insertion holes 232 of each of the connection interfaces 230, hereby combining and integrating a swappable function expansion component with a communication device main-body into an integral mobile communication device. Some of the insertion pins of swappable function expansion component are embedded with metal plates 142, and some of the insertion holes of connection interfaces 230 are also embedded with metal plates 234 and 236. As such, when a swappable function expansion component is inserted into the communication device main-body, metal plates 142 are in contact with metal plates 234 and 236. Thus, the communication device main-body is electrically connected to the swappable function expansion component through metal plates 142, 234, and 236, hereby providing the power required by the swappable function expansion component, and transmitting the control signals in controlling the operations of the swappable function expansion component.

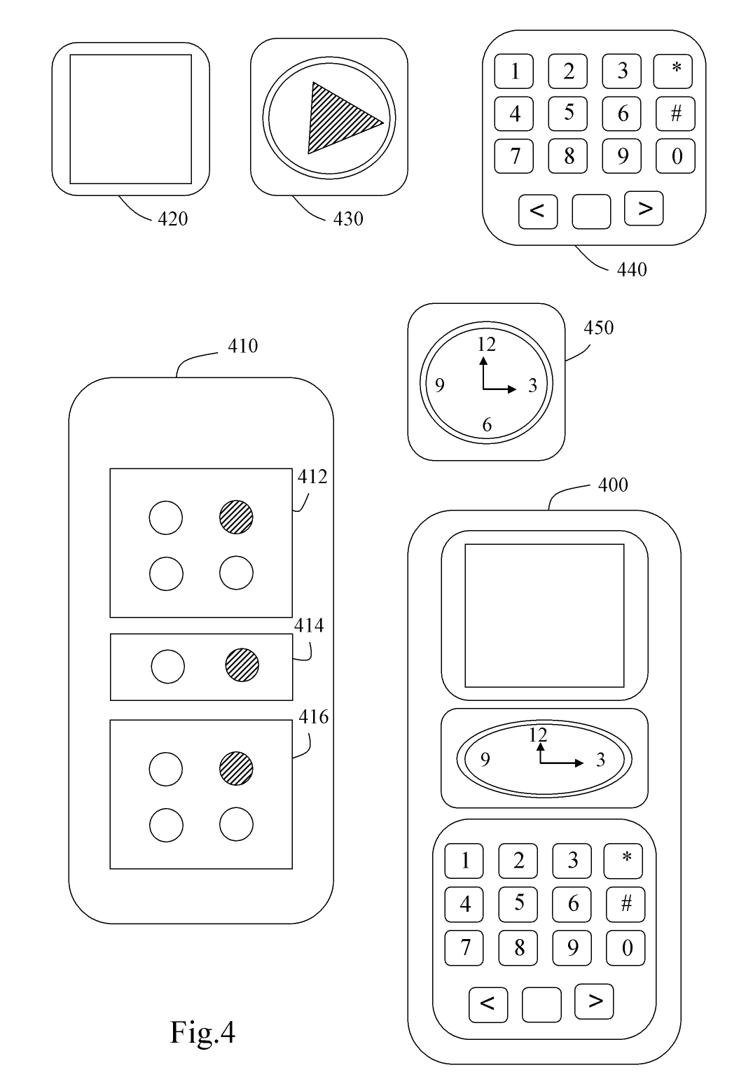

Furthermore, refer to FIG. 4 for a schematic diagram of another combinational mobile communication device according to another embodiment of the invention. As shown in FIG. 4, the mobile communication device 400 of the present embodiment is composed of a communication device main-body 410 and three swappable function expansion components. The swappable function expansion components that can be selected to use include: touch screen module 420, pressure sensor control key module 430, telephone keypad module 440, and clock module 450. A user may select the swappable function expansion components desired to be used and put them into the connection interfaces 412, 414, and 416 on a communication device main-body 410. Each of the respective connection interfaces 412,414, and 416 is provided with a number of round-shaped insertion holes, each having an embedded metal plate. The bottom of a swappable function expansion component is provided with a round-shaped insertion pin (not shown), and that is inserted into the round-shaped insertion hole mentioned above, hereby combining and integrating the swappable function expansion component and communication device main-body 410 together into an integral unit. Likewise, the bottom of a swappable function expansion component is also provided with round-shaped insertion pins having embedded metal plates. As such, when these insertion pins are inserted into those insertion holes, the embedded metal plates of the insertion pins are in contact with the embedded metal plates of the insertion holes, thus, communication device main-body 410 may provide electric power or transmit control signals to the respective swappable function expansion components. All the respective connection interfaces 412,414, and 416 on a communication device main-body 410 may be inserted with various kinds of swappable function expansion components (in the present embodiment, such as touch screen module 420, telephone keypad module 440, and clock module 450), hereby combining and integrating the two units into an integral mobile communication device 400, thus the functions of various kinds of swappable function expansion components can be utilized and realized in this manner.

Summing up the above, the combinational mobile communication device of the invention can be divided into two separate portions of a swappable function expansion components and a communication device main-body respectively, as such, various additional functions required can be added and realized through the related swappable function expansion components. In this manner, various swappable function expansion components can be attached/detached as required, and thus are combined and integrated with a communication device main-body into an integral mobile communication device. As such, the present invention realizing the expanded functions of the mobile communication device as required by a user through the exchange of different operation interfaces. The advantages of the combinational mobile communication device of the invention can be summarized as follows:

1. Upon changing or expanding the functions of mobile phone handset, the overall outer appearance of the mobile phone handset tends to remain consistent, and the volume of a handset will not increase due to the function expansion of the handset;

2. Various swappable function expansion components can be attached/detached simultaneously, and that is quite an improvement over the prior art that a mobile phone handset function expansion is achieved through an outside attached module inserted into an expansion connection port, and only a single module can be outside attached at one time; and

3. A user may choose the ordinarily utilized swappable function expansion components, attaching or detaching such swappable function expansion components, thus adding or removing specific functions to or from a mobile communication device depending on the requirements of the existing environment of a user.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A combinational mobile communication device, comprising:
at least a swappable function expansion component, including:
a shell, used to form a part of an outer shell of said combinational mobile communication device; and
a function expansion module, disposed in said shell, and is used to provide at least an expanded function for said combinational mobile communication device to select and utilize; and
a communication device main-body, can be combined with said shell into said integral combinational mobile communication device,
said communication device main-body includes:
at least a connection interface, the bottoms of said connection interfaces are provided each with at least an insertion hole, and that is used to combine said swappable function expansion component with said communication device main-body; and
a main-body, upon detecting the connection of said swappable function expansion components to said connection interfaces, providing power to said swappable function expansion components as required for their normal operation.

2. The combinational mobile communication device as claimed in claim 1, wherein
some of said insertion holes of said connection interfaces are provided each with embedded metal plates, and that are used to connect electrically to said swappable function expansion components.

3. The combinational mobile communication device as claimed in claim 1, wherein
said communication device main-body further includes a microprocessor, and is used to generate a control signal to drive said swappable function expansion components, when said swappable function expansion components are connected to said connection interfaces.

4. The combinational mobile communication device as claimed in claim 3, wherein
said microprocessor is used to determine if said swappable function expansion components are connected to said connection interfaces through detecting the current or voltage variations on said metal plates of said insertion holes.

5. The combinational mobile communication device as claimed in claim 3, wherein
said microprocessor is used to determine the type of said swappable function expansion components plugged in based on the data carried by an electrical signal as read from said metal plates by said microprocessor.

6. The combinational mobile communication device as claimed in claim 1, wherein
said communication device main-body further includes a memory, and that is used to store the data received by said swappable function expansion components.

7. The combinational mobile communication device as claimed in claim 6, wherein
said communication device main-body is further utilized to selectively remove the data stored in said memory, upon detaching said swappable function expansion components.

8. The combinational mobile communication device as claimed in claim 3, wherein
upon receiving the signals of an incoming call, said microprocessor generates a control signal in controlling the operations of said swappable function expansion components.

9. The combinational mobile communication device as claimed in claim 1, wherein
said swappable function expansion components can be selected from one of the following comprising the group of: telephone keyboard module, pressure sensor control key module, touch screen module, fingerprint identification module, music broadcaster module, back cover module, camera back cover module, clock module, and memory expansion back cover module.

10. The combinational mobile communication device as claimed in claim 1, wherein
said shell further includes a connection port used to transmit data.

11. A communication device main-body, used to combine with at least a swappable function expansion component into a mobile communication device, said communication device main-body includes:
at least a connection interface, the bottoms of said connection interfaces are provided each with at least an insertion hole, and that is used to connect to said swappable function expansion component to form an integral combinational mobile communication device; and
a main-body, upon detecting the connection of said swappable function expansion components to said connection interfaces, providing power to said swappable function expansion components as required for their normal operation.

12. The communication device main-body as claimed in claim 11, wherein
some of said insertion holes of said connection interfaces are provided each with embedded metal plates, and that are used to connect electrically to said swappable function expansion components.

13. The communication device main-body as claimed in claim 11, wherein
said communication device main-body further includes a microprocessor, and is used to generate a control signal to drive said swappable function expansion components, when said swappable function expansion components are connected to said connection interfaces.

14. The communication device main-body as claimed in claim 13, wherein
said microprocessor is used to determine if said swappable function expansion components are connected to said connection interfaces through detecting the current or voltage variations on said metal plates of said insertion holes.

15. The communication device main-body as claimed in claim 13, wherein
said microprocessor is used to determine the type of said swappable function expansion components plugged in based on the data carried by an electrical signal as read from said metal plates by said microprocessor.

16. The communication device main-body as claimed in claim 11, wherein
said communication device main-body further includes a memory, and that is used to store the data received by said swappable function expansion components.

17. The communication device main-body as claimed in claim 16, wherein
said communication device main-body is further utilized to selectively remove the data stored in said memory, upon detaching said swappable function expansion components.

18. The communication device main-body as claimed in claim 13, wherein
upon receiving the signals of an incoming call, said microprocessor generates a control signal in controlling the operations of said swappable function expansion components.

19. A swappable function expansion component that can be combined with the communication device main-body as claimed in claim 11, comprising:
a shell, that forms a portion of an outer shell of said communication device main-body; and a function expansion module and a controller arranged at said shell, said shell combines with said communication device main-body into a mobile communication device through at least insertion pin at the bottom of said shell, said controller is connected electrically to said communication device main-body through the embedded metal plates of some of said insertion pins at the bottom of said shell, and is used to receive a control signal in activating or terminating the added function provided by said swappable function expansion component.

20. The swappable function expansion component as claimed in claim 19, wherein
said swappable function expansion components can be selected from one of the following comprising the group of: telephone keyboard module, pressure sensor control key module, touch screen module, fingerprint identification module, music broadcaster module, back cover module, camera back cover module, clock module, and memory expansion back cover module.

21. The swappable function expansion component as claimed in claim 19, wherein
said shell further includes a connection port used to transmit data.
